(19) United States
(12) Patent Application Publication
(10) Pub. No.: US 2025/0138498 A1
(43) Pub. Date: May 1, 2025

(54) IOT-BASED HOME MANAGEMENT SYSTEM AND THE CONTROL METHOD THEREOF

(71) Applicant: Reset Group Incorporated, Fairfax, VA (US)

(72) Inventors: William Bruner, Fairfax, VA (US); Jiyoung Goo, Fairfax, VA (US)

(73) Assignee: Reset Group Incorporated, Fairfax, VA (US)

(21) Appl. No.: 18/931,058

(22) Filed: Oct. 30, 2024

(30) Foreign Application Priority Data
Nov. 1, 2023 (KR) 10-2023-0148712

(51) Int. Cl. G05B 15/02

(52) U.S. Cl. CPC G05B 15/02

(57) ABSTRACT

An IoT-based home management system includes a server that performs reservation and management for one or more homes, a user terminal device that transmits reservation information and environment setting information on a selected home to the server, and an IoT control device that is provided in each of the one or more homes and sets an IoT environment of the selected home in response to a reservation date and time selected by a user based on the reservation information and environment setting information received from the server. Accordingly, the environment of the home may be automatically controlled by the reserved date and time according to the online reservation information and environment setting information and the user may live in the home set to the environment he/she wants, thereby increasing user convenience and satisfaction.

### CROSS REFERENCE TO RELATED APPLICATION(S)

This application claims priority to and benefits of Korean Patent Application No. 10-2023-0148712 under 35 U.S.C. § 119, filed on Nov. 1, 2023, in the Korean Intellectual Property Office (KIPO), the entire contents of which are incorporated herein by reference.

### BACKGROUND

### 1. Technical Field

The present disclosure relates to a management system, e.g., an IoT-based (Internet of Things-based) tiny home management system and a control method thereof, and more particularly, to an IoT-based tiny home management system capable of setting an IoT environment of a tiny home and other built environments according to online reservation information, and a control method thereof.

### 2. Description of Related Art

In recent years, the diversification of individual lifestyles has led to an increasing trend where people choose to live in various built environments for different periods, in addition to their primary residence. These built environments include not only traditional rental spaces such as hotels and rental residences but also other spaces such as student housing, senior assisted living facilities, permanent residences, tiny homes, and more.

To cater to this growing variety of living spaces, it is essential to have a new technology that can be implemented across different types of built environments. This technology should be capable of being requested and deployed by property owners, property management companies, or other stakeholders involved in managing these spaces. The aim of the technology is to offer versatile monitoring and control solutions to efficiently manage building utilities, security, and maintenance for different built environments, adapting to varying needs and structures.

When we refer to an IoT-based “tiny home” management system and control method, it does not mean the system is limited to tiny homes. Rather, the idea is that since the system is designed to perform effectively in the relatively harsher conditions often associated with tiny homes, it will be even more adaptable and applicable to other built environments. The typical conditions for tiny homes include:
Limited external power, relying on portable batteries or solar panels.
Remote or undeveloped locations, often exposed to natural elements like forests or open land.
Homes spaced sporadically across a large area.
A range of home sizes, from 100 sq. ft. to thousands of sq. ft., depending on design.

Furthermore, this new technology may support power supply options that align with the diverse characteristics of these environments. It should be compatible with general power grids and should also provide flexibility to function with independent power sources, such as portable batteries. This is also desired for smaller or movable spaces like tiny homes, which may rely on independent power systems rather than traditional grid connections. By supporting these independent power systems, the technology can offer enhanced management and monitoring capabilities, ensuring efficiency and convenience in any type of built environment.

Thus, the development of a technology that enables the monitoring, controlling, and managing power and water usage of various built environments, whether connected to the main grid or independent power sources, is becoming increasingly necessary.

### SUMMARY

The present disclosure provides an IoT-based home management system capable of not only setting an IoT environment of a home according to reservation information online, but also optimizing energy consumption, and a control method thereof.

According to an aspect of the present disclosure, an IoT-based home management system includes a server that performs reservation and management for one or more homes, a user terminal device that transmits reservation information and environment setting information on a selected home to the server, and an IoT control device that is provided in each of the one or more homes and sets an IoT environment of the selected home in response to a reservation date and time selected by a user based on the reservation information and environment setting information received from the server, in which the IoT control device transmits information on an IoT environment setting history of the selected home to the server, and the server updates the information on the IoT environment setting history of the selected home to usage history information of the user, and utilizes the usage history information for IoT environment setting of a home selected by a next reservation of the user.

The environment setting information may include information for setting an IoT-based controllable device provided in the selected home, and include information for setting the IoT-based controllable device differently by each reservation date and time.

The IoT control device may include a communication unit that receives reservation information and environment setting information on the selected tiny home from the server, an identification unit that identifies the user, a status detection unit that monitors a status of an IoT-based controllable device provided in the selected tiny home, and a processor that sets the IoT-based controllable device provided in the selected tiny home differently by the reservation date and time selected by the user when the user is identified through the identification unit.

The server may predict power consumption of the IoT-based controllable device provided in the selected tiny home based on the reservation information and environment setting information on the selected tiny home and transmit predicted power consumption information to the IoT control device, and the IoT control device may calculate the power consumption of the IoT-based controllable device provided in the selected tiny home in real time, and compare the power consumption calculated in real time with the predicted power consumption information.

The IoT control device may further include an electrical energy check unit that checks a charge amount of a recycled battery provided in the selected tiny home; and the processor may calculate an increase/decrease rate of the power consumption calculated in real time, and compare the calculated increase/decrease rate with the charge amount of the recycled battery to calculate a power supply available time.

The processor may determine whether to replace the recycled battery based on the calculated power supply available time, transmit battery replacement request information to the server, and settle a usage cost of the selected tiny home based on the power consumption calculated in real time.

The IoT control device may further include sensor unit that detects movement of the user, and when the sensor unit determines that a risk situation occurs based on the detected movement of the user, the IoT control device may transmit risk situation notification information to the server.

According to another aspect of the present disclosure, a control method of an IoT-based home management system including a server, a user terminal device, and an IoT control device, includes performing, by a server, reservation and management for one or more homes, transmitting, by the user terminal device, reservation information and environment setting information on a selected home to the server, setting, by the IoT control device, an IoT environment of the selected home in response to a reservation date and time selected by a user based on the reservation information and environment setting information received from the server, transmitting, by the IoT control device, information on an IoT environment setting history of the selected home to the server, and updating, by the server, the information on the IoT environment setting history of the selected home to usage history information of the user and utilizing the usage history information for IoT environment setting of a home selected by a next reservation of the user.

The environment setting information may include information for setting an IoT-based controllable device provided in the selected home, and include information for setting the IoT-based controllable device differently by each reservation date and time.

The IoT control device may include a communication unit that receives reservation information and environment setting information on the selected home from the server; an identification unit that identifies the user; a status detection unit that monitors a status of an IoT-based controllable device provided in the selected home; and a processor that sets the IoT-based controllable device provided in the selected home differently by the reservation date and time selected by the user when the user is identified through the identification unit.

The control method may further include predicting, by the server, power consumption of the IoT-based controllable device provided in the selected home based on the reservation information and environment setting information on the selected home and transmitting predicted power consumption information to the IoT control device, and calculating, by the IoT control device, the power consumption of the IoT-based controllable device provided in the selected home in real time, and comparing the power consumption calculated in real time with the predicted power consumption information.

The control method may further include checking, by an electrical energy check unit of the IoT control device, a charge amount of a recycled battery provided in the selected home; and calculating, by the processor, an increase/decrease rate of the power consumption calculated in real time, and comparing the calculated increase/decrease rate with the charge amount of the recycled battery to calculate a power supply available time.

The control method may further include determining, by the processor, whether to replace the recycled battery based on the calculated power supply available time, transmitting battery replacement request information to the server, and settling a usage cost of the selected home based on the power consumption calculated in real time.

The IoT control device may further include a sensor unit that detects movement of the user, and the control method may further include transmitting, by the IoT control device, risk situation notification information to the server when the sensor unit determines that a risk situation occurs based on the detected movement of the user.

It is to be understood that the embodiments above are described in a generic and explanatory sense only and not for the purpose of limitation, and the disclosure is not limited to the embodiments described above.

### BRIEF DESCRIPTION OF DRAWINGS

FIG. 1 is a diagram schematically illustrating a configuration of an IoT-based tiny home management system according to an embodiment of the present disclosure.

FIG. 2 is a diagram schematically illustrating a configuration of an IoT control device according to an embodiment of the present disclosure.

FIGS. 3 and 4 are diagrams schematically illustrating a usage example of an IoT-based controllable device according to an embodiment of the present disclosure.

FIG. 5 is a diagram schematically illustrating a configuration of an IoT control device according to another embodiment of the present disclosure.

FIG. 6 is a diagram schematically illustrating a display of the IoT control device according to an embodiment of the present disclosure.

FIG. 7 is a diagram schematically illustrating a configuration of the IoT control device according to another embodiment of the present disclosure.

FIG. 8 is a diagram schematically illustrating a risk situation notification system of a tiny home according to an embodiment of the present disclosure.

FIG. 9 is a block diagram schematically illustrating a more detailed configuration of the IoT control device according to an embodiment of the present disclosure.

FIG. 10 is a diagram schematically illustrating a software module stored in a storage unit according to an embodiment of the present disclosure.

FIG. 11 is a flowchart schematically illustrating a control method of an IoT-based tiny home management system according to an embodiment of the present disclosure.

### DETAILED DESCRIPTION OF THE EMBODIMENTS

Hereinafter, embodiments of the present disclosure will be described in more detail with reference to the accompanying drawings. In addition, in describing the present disclosure, when it is decided that a detailed description for known functions or configurations related to the present disclosure may obscure the gist of the present disclosure, the detailed description thereof may be omitted. Further, terms to be described later are defined in consideration of functions in the present disclosure and may be changed depending on the intention or relationship of users and operators. Therefore, these terms should be defined based on contents throughout the present specification.

As the disclosure allows for various changes and numerous embodiments, some embodiments will be illustrated in the drawings and described in detail in the written description. However, this is not intended to limit the disclosure to particular modes of practice, and it is to be appreciated that all changes, equivalents, and substitutes that do not depart from the spirit and technical scope of the disclosure are encompassed in the disclosure.

It will be further understood that the terms “comprise,” “include,” “have,” and the like, when used in this specification, specify the presence of stated features, integers, steps, operations, elements, components, and/or combinations of them but do not preclude the presence or addition of one or more other features, integers, steps, operations, elements, components, and/or combinations thereof.

As is standard practice in the field, certain embodiments are described and depicted in the accompanying drawings using functional blocks, units, components, and/or modules. Those skilled in the art will recognize that these blocks, units, components, and/or modules are physically realized by electronic (or optical) circuits, including but not limited to logic circuits, discrete elements, microprocessors, hard-wired circuits, memory elements, wiring connections, and similar components. These may be fabricated using semiconductor-based processes or other manufacturing technologies. In cases where the blocks, units, components, and/or modules are implemented via microprocessors or comparable hardware, they may be programmed and managed using software (e.g., microcode) to execute various functions described herein and may also be driven by firmware and/or software. It is further contemplated that each block, unit, component, and/or module may be implemented using dedicated hardware or a combination of dedicated hardware for specific functions alongside a processor (e.g., one or more programmed microprocessors and associated circuitry) to execute other functions. Additionally, each block, unit, component, and/or module in certain embodiments may be divided into two or more interacting and discrete elements without departing from the scope of this disclosure. Conversely, the blocks, units, components, and/or modules of some embodiments may be integrated into more complex structures without deviating from the scope of the disclosure.

The term “when” as used herein refers to a condition, event, occurrence, or specific set of circumstances that takes place at a particular moment or period, which may include (i) a case, representing an instance, situation, or scenario in which specific criteria or conditions are met, and/or (ii) a time, representing a point or interval in chronological order. The use of “when” is intended to describe both the causative or conditional relationship between one action, state, or event and another, and the temporal association that situates actions, states, or events within a timeline or order of execution.

The term “connect” as used herein refers to establishing a physical, electrical, or communicative link between two or more components, devices, or systems. This includes, but is not limited to, (i) physical connect, wherein a tangible, mechanical attachment or joining occurs between elements, (ii) electrical connect, wherein an electrical pathway is established to allow the transfer of electrical signals, power, or data, and (iii) wired and wireless connection, wherein the connection can be achieved through physical cabling or through wireless technologies such as radio frequency, infrared, or other wireless communication protocols. The term “connect” also encompasses both direct connections, where the components are linked without intermediaries, and indirect connections, where one or more intermediate components, devices, or systems facilitate the connection between the primary elements.

A “processor” as used herein refers to a physical or virtual computing component that is capable of executing instructions and performing data processing tasks. The processor may include one or more central processing units (CPUs), microprocessors, application-specific integrated circuits (ASICs), graphics processing units (GPUs), field-programmable gate arrays (FPGAs), digital signal processors (DSPs), or a combination thereof. It may be configured to execute various algorithms, perform arithmetic and logic operations, and control other components within a computing environment. The processor may also interface with memory and storage units to access, retrieve, and process data as needed.

Unless otherwise defined or implied herein, all terms (including technical and scientific terminology) used in this document retain their commonly understood meanings as recognized by those skilled in the relevant field. Furthermore, it is to be understood that terms, including those defined in standard dictionaries, should be interpreted in a manner that is consistent with their usage within the context of the relevant field and this disclosure. These terms should not be construed in an idealized or overly formal sense unless explicitly specified otherwise herein.

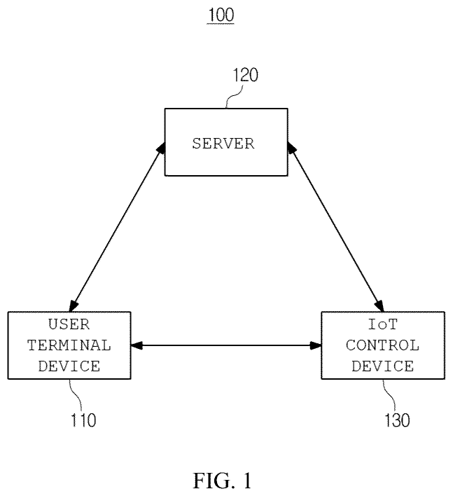

FIG. 1 is a drawing schematically illustrating a configuration of an IoT-based tiny home management system according to an embodiment of the present disclosure.

Referring to FIG. 1, an IoT-based tiny home management system 100 according to an embodiment of the present disclosure may include a user terminal device 110, a server 120, and an IoT control device 130.

Here, the IoT-based tiny home management system 100 may mean a system that manages one or more tiny homes. The management may cover management of reservations, maintenance, supply of power, facility check, etc., for each of the one or more tiny homes.

The “tiny home” as described in the present disclosure may mean a compact house in the dictionary sense. Additionally, the tiny home may include a house that is provided with wheels and/or can be moved, and may also include the meaning of a dwelling unit as well as a physical form such as a house.

Here, the dwelling unit may mean a residential area of all forms and methods that can be rented and set up in an environment, even if it is not necessarily a house in a physical form.

In embodiments, the present disclosure may be applied to all types of built environment within the scope and spirit of the disclosure. For example, the present disclosure is applicable to rental houses, student housing, senior assisted living facilities, residential homes.

In operating the IoT-based tiny home management system 100, the user terminal device 110, the server 120, and the IoT control device 130 may play significant roles. Here, the server 120 may perform reservation and management for the one or more tiny homes, and the user terminal device 110 may transmit reservation information and environment setting information regarding a selected tiny home to the server 120.

For example, the server 120 may operate an online site where reservations may be made for each of the one or more tiny homes, and may also perform a management function of monitoring and controlling the facilities and environments of each of the one or more tiny homes through a wireless communication connection with each of the one or more tiny homes.

The user terminal device 110 may access the online reservation site operated by the server 120, and the user may select a desired tiny home on the online reservation site, set a reservation date and time for the selected tiny home, and transmit information for presetting the environment for the selected tiny home to the server 120.

In an embodiment, the IoT control device 130 may be provided in each of the one or more tiny homes, and may set the IoT environment of the selected tiny home in response to the reservation date and time selected by the user based on the reservation information and environment setting information received from the server 120.

Specifically, the IoT control device 130 may be implemented as a control panel mounted on a wall or a surface of the tiny home, and the IoT control device 130 may be connected to various electronic devices mounted in the tiny home, e.g., any device that may be connected and controlled via wireless communication, as well as the server 120, via various wireless communication methods.

Here, the wireless communication method may include various communication methods such as Bluetooth, Internet of Things (IoT), Wireless Fidelity (or Wi-Fi), Zigbee, Infrared (IR), Serial Interface, Universal Serial Bus (USB), Long Range (LoRa), Long-Term Evolution (LTE), etc.

For example, the IoT control device 130 may perform communication with the user terminal device 110 and a cloud server, and may be linked with any or all devices connected to the cloud server.

As another example, the IoT control device 130 may perform communication with the user terminal device 110 and the server 120, and may also perform direct communication with various electronic devices provided in the tiny home.

The environment setting information here may include, for example, information for setting IoT-based controllable devices provided in the tiny home selected by the user from an online reservation site, and may include information for setting IoT-based controllable devices differently according to reservation date and time.

For example, the IoT-based controllable devices may include any device capable of IoT communication and control, such as refrigerators, TVs, curtain control devices, lighting control devices, temperature/humidity control devices, air conditioners, and cold/hot water control devices. For example, when the environment setting information is set up such that the reservation date is September 7th and the reservation time is set to open curtains at 9:00 AM and close the curtains at 12:00 AM, the IoT control device 130 of the selected tiny home may control a curtain control device to open the curtains at 9:00 AM and close the curtains at 12:00 AM on September 7th.

In this way, the functions and operations of the IoT-based controllable device may be controlled differently according to environment setting information set for each reservation time zone as well as the reservation date.

The IoT control device 130 according to an embodiment of the present disclosure may transmit information on an IoT environment setting history of the selected tiny home to the server 120, and the server 120 may update the information on the IoT environment setting history of the selected tiny home to usage history information of a user, and may utilize the updated information for IoT environment setting of the selected tiny home by the next reservation of the user.

For example, when the information on the set or changed history of the IoT-based controllable devices during a reservation period for a tiny home (“tiny home A”) selected and reserved by the user is transmitted to the server 120, the server 120 may update the information on the set or changed history to the information on the IoT environment setting history by reservation date in the usage history information for each user and store the updated information.

Accordingly, the server 120 may check how users set the IoT-based controllable devices provided inside the tiny home A during the reservation period of the tiny home A and how the users change the IoT-based controllable devices in real time during the period of residence, and may utilize the set or changed history information for the IoT environment setting of the selected tiny home by the next reservation of the user.

For example, when the same user makes a reservation for a tiny home (“tiny home B”) again, at the time the user makes a reservation for the tiny home B, the server 120 may propose whether to apply the same settings for the tiny home B as the server 120 already has set up the IoT-based controllable devices previously provided in the tiny home A.

The server 120 may transmit to the IoT control device 130 provided in the tiny home B a control command to automatically change the environment settings of the IoT-based controllable devices through the IoT control device 130 provided in the tiny home B by referring to the history of previous changes made to settings in the tiny home A during a period in which the same user resides or stays in the tiny home B.

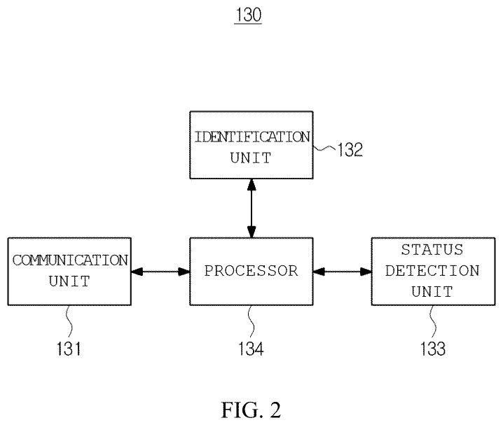

FIG. 2 is a diagram schematically illustrating a configuration of an IoT control device according to an embodiment of the present disclosure.

An IoT control device 130 according to an embodiment of the present disclosure may include a communication unit 131, an identification unit 132, a status detection unit 133, and/or a processor 134.

The communication unit 131 may receive reservation information and environment setting information regarding a selected tiny home from the server 120, and may utilize various communication methods. Examples of the communication unit 131 may include, but are not limited to, a Wi-Fi Module (e.g., ESP8266, ESP32, etc.), Bluetooth Module (e.g., HC-05, HC-06, BLE-enabled devices, etc.), Zigbee Module (e.g., XBee, etc.), LoRa Module (e.g., SX1276, etc.), Cellular Module (e.g., SIM800, SIM900, LTE-M, NB-IoT, etc.), RFID Module, NFC (Near Field communication) Module, Infrared Module, Serial Communication Module (e.g., RS232, RS485, UART, etc.), Ethernet Module (e.g., ENC28J60, W5100, etc.), software algorithm, and a combination thereof. A detailed description thereof will be omitted.

The identification unit 132 may identify a user. Specifically, the identification unit 132 may be implemented as a camera, various sensors, NFC, etc. When the identification unit 132 is implemented as the camera, the identification unit 132 may identify a user by capturing a face image of a user and comparing and matching the identified user with a stored image, and when the identification unit 132 is implemented as the NFC, if the user terminal device 110 is tagged, the identification unit 132 may identify the user by comparing and matching the tagged user terminal device 110 information with the stored phone number of the user, or by comparing and matching the key information stored in the user terminal device 110 with the stored key information.

The status detection unit 133 may monitor the status of the IoT-based controllable device provided in the selected tiny home. For example, when the IoT-based control device is a refrigerator, the status detection unit 133 may obtain information on the current temperature and freezing temperature of the refrigerator, when the IoT-based control device is a TV, the status detection unit 133 may obtain information on what channel is currently being displayed, what the volume is, and when the IoT-based control device is a temperature/humidity control device, the status detection unit 133 may obtain information on what the current temperature and humidity are. Examples of the status detection unit 133 may include, but are not limited to, a sensor (e.g., temperature sensor, humidity sensor, motion sensor, light sensor, etc.), camera, software algorithm, and a combination thereof.

When the user is identified through the identification unit 132, the processor 134 may set the IoT-based controllable device provided in the selected tiny home differently by the reservation date and time selected by the user.

for example, the processor 134 may control all the IoT-based controllable devices provided in the tiny home by the reservation date and time selected by the user based on the reservation information and environment setting information received from the server 120 from the moment the user is identified through the identification unit 132.

Accordingly, when the user is not identified through the identification unit 132, the processor 134 does not control (or inactivates) the IoT-based controllable devices provided in the tiny home even if the reservation information and environment setting information received from the server 120 exist, and this may efficiently manage the power consumption of the tiny home.

For example, when the user does not show up until the reservation time and is not identified or another user is identified while the reservation information and environment setting information is received from the server 120, the processor 134 may not activate the control of the IoT-based controllable devices provided in the tiny home according to the received reservation information and environment setting information.

In other words, when a person other than a user registered in a reserved tiny home is identified, the processor 134 may inactivate control of the IoT-based controllable device provided inside the tiny home even if the entry into the tiny home is possible to restrict the environment settings requested by the registered user and maintain only the basic performance of the IoT-based controllable device provided in the tiny home, thereby efficiently managing the power consumption of the tiny home.

The processor 134 may automatically perform a pairing function when the IoT-based controllable device newly enters the tiny home to enable communication connection. For example, when the user terminal device 110 enters the tiny home, the processor 134 may automatically recognize the user terminal device 110 and performs pairing with the user terminal device 110 for connection, thereby allowing the user to control the IoT control device 130 through the user terminal device 110 or control various IoT-based controllable devices connected to the IoT control device 130.

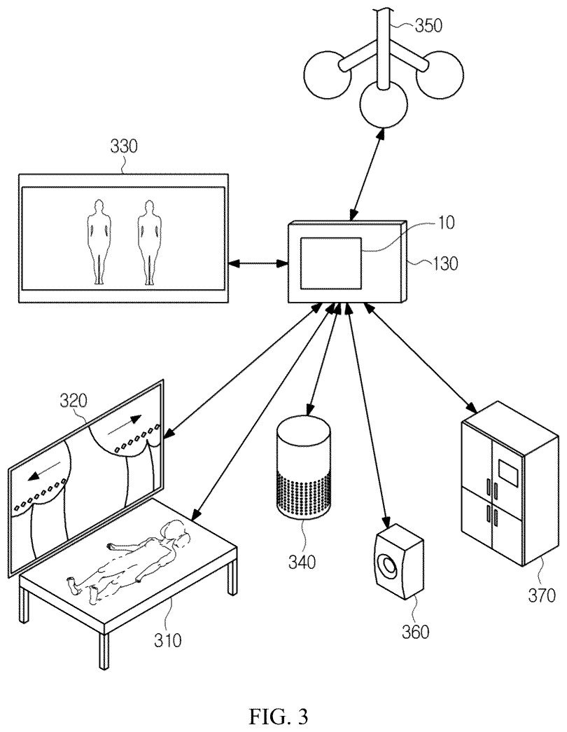

FIGS. 3 and 4 are diagrams schematically illustrating a usage example of an IoT-based controllable device according to an embodiment of the present disclosure.

Referring to FIG. 3, a bed 310, a curtain control device 320, a TV 330, an air purifier 340, a lighting 350, a speaker 360, and a refrigerator 370 provided inside the tiny home may be connected to the IoT control device 130, and a display unit 10 of the IoT control device 130 may display a screen that may display the status of various devices connected in this way or control the devices.

For example, according to the environment setting information requested by the user on the online reservation site, the IoT control device 130 may set the temperature of the bed 310 differently according to the reservation time zone, e.g., lower the temperature at 12 o'clock in the afternoon and raise the temperature to 35° C. at 12 o'clock at night, and in the case of the curtain control device 320, all curtains may be opened at 9 o'clock in the morning and closed at 6 o′clock in the evening.

The IoT control device 130 may control the TV 330 to display a preset news broadcast on channel 7 at 7 PM, or the air purifier 340 to always maintain a cleanliness level above the preset level.

The IoT control device 130 may control the lighting 350 to turn on to white lighting with an illuminance of 80 or higher from 6 PM to 8 PM, turn on to yellow indirect lighting with an illuminance of 60 from 8 PM to 11 PM, and change to sleeping lighting with an illuminance of 30 after 11 PM.

The IoT control device 130 may automatically select and play fast-tempo music at 9 AM for the speaker 360, and automatically select and play quiet and gentle slow-tempo music at 7 PM.

Referring to FIG. 4, an interior of the bathroom is illustrated, and a lighting mirror 410, a shower 420, a bathtub 430, and a washbasin faucet 440, etc., provided in the bathroom may be connected to the IoT control device 130.

For example, according to the environment setting information requested by the user on the online reservation site, the IoT control device 130 may control the illuminance and color of the light mirror 410, control the temperature and strength of water discharged through the shower 420, and automatically fill the bathtub 430 with water at a temperature of 30° C. at 3:00 PM, and control the temperature and strength of the water discharged through the washbasin faucet 440. A water meter may be used to keep track of water usage.

As described above, the IoT control device 130 may control any or all the IoT-based controllable devices provided in the tiny home when the wireless communication is possible, and may control the IoT-based controllable devices according to the environment setting information input by the user.

The server 120 according to an embodiment of the present disclosure may predict (or determine) the power consumption of the IoT-based controllable device provided in the selected tiny home based on the reservation information and environment setting information on the selected tiny home, and transmit the predicted power consumption information to the IoT control device 130.

The server 120 may extract power consumption data of a previous tiny home of a user based on the information on the IoT environment setting history of the selected tiny home as described above through machine learning or big data, predict a behavioral pattern of the user during the period of residence in the tiny home based on the extracted power consumption data and the user profile information input by the user at the time of reservation, and predict the power consumption during the period of residence based on the predicted behavioral pattern of the user.

The IoT control device 130 may calculate the power consumption of the IoT-based controllable device provided in the selected tiny home in real time, and compare the power consumption calculated in real time with the predicted power consumption information.

For example, the server 120 may predict the power consumption of the selected IoT-based controllable device based on a usage time, a usage cycle, and functions to be performed, etc., of the device selected from among IoT-based controllable devices provided in the tiny home based on the reservation information and environment setting information on the selected tiny home.

The IoT control device 130 may calculate the actual power consumption of the selected device from among the IoT-based controllable devices provided in the selected tiny home in real time, and compare the predicted power consumption received from the server 120 with the actual power consumption calculated in real time.

The IoT control device 130 may transmit a result value of comparing the received predicted power consumption with the actual power consumption calculated in real time to the server 120, so the server 120 may correct and update the predicted power consumption during the residence period of the user.

For example, the server 120 may predict the power consumption during the reserved residence period of the tiny home in advance at the time when the user wants to make a reservation again based on the reservation information and environment setting information of the past tiny home of the user, the power consumption data during the actual residence period, the user profile information, etc., and the IoT control device 130 may aggregate the actual power consumption calculated in real time and transmit the comparison value with the predicted power consumption to the server 120 to correct and update the predicted power consumption.

The IoT control device 130 may further include an electrical energy check unit that checks the charge amount of the recycled battery provided in the selected tiny home.

In order to provide smooth battery energy storage systems (BESS), the tiny home according to an embodiment of the present disclosure may supply power to the tiny home by utilizing the recycled battery. The recycled battery may include a waste battery or a used battery of an electric vehicle, or various usable waste batteries.

The recycled battery is attached to some areas of the tiny home and is responsible for supplying power to the tiny home, and when the charge amount is completely consumed, the recycled batteries are detachable and may be replaced.

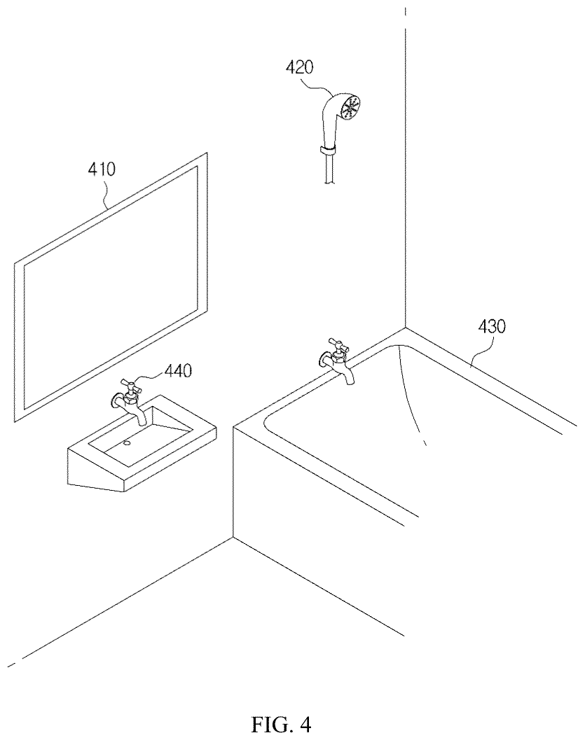

FIG. 5 is a diagram schematically illustrating a configuration of an IoT control device according to another embodiment of the present disclosure.

Referring to FIG. 5, the IoT control device 130 according to another embodiment of the present disclosure may include the communication unit 131, the identification unit 132, the status detection unit 133, the processor 134, and/or an electrical energy check unit 135.

Here, the electrical energy check unit 135 may check the charge amount of a recycled battery provided in the selected tiny home. Examples of the electrical energy check unit 135 may include, but are not limited to, a sensor, multimeter, testers, Battery Management System, software algorithm, and a combination thereof.

The processor 134 may calculate an increase/decrease rate of power consumption calculated in real time, and calculate a power supply available time by comparing the calculated increase/decrease rate with the charge amount of the battery.

For example, the processor 134 may check the increase/decrease rate of the actual power consumption of the device selected from among the IoT-based controllable devices calculated in real time in a time unit, and calculate the increase/decrease rate, and may compare the calculated increase/decrease rate of the power consumption with the charge amount of the recycled battery provided in the tiny home to calculate the power supply available time for how long power may be supplied in the future.

The processor 134 may determine whether to replace the recycled battery based on the calculated power supply available time, transmit battery replacement request information to the server 120, and settle (or determine) the usage cost of the selected tiny home based on the power consumption calculated in real time.

For example, when the calculated power supply available time is less than equal to a preset time, for example, 2 hours, the processor 134 may determine that the recycled battery needs to be replaced, and transmit the battery replacement request information to the server 120 to replace the recycled battery.

The processor 134 may calculate a discount rate for a reservation amount for the tiny home based on the power consumption calculated in real time to settle the usage cost of the tiny home.

For example, when the power consumption calculated in real time is 20% lower than the preset power consumption, the processor 134 may calculate the discount rate for the reservation amount for the tiny home as 20%, and when the power consumption is 10% lower than the preset power consumption, the processor 134 may calculate the discount rate for the reservation amount for the tiny home as 10%.

Of course, the processor 134 may calculate an additional rate for the reservation amount for the tiny home as 10% when the power consumption calculated in real time is 10% higher than the preset power consumption.

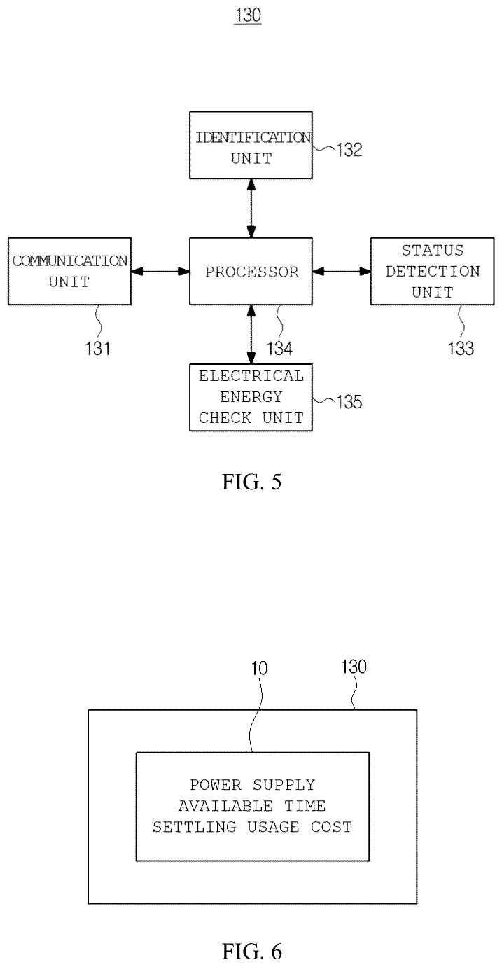

FIG. 6 is a diagram schematically illustrating a display of the IoT control device according to an embodiment of the present disclosure.

Referring to FIG. 6, the display 10 of the IoT control device 130 may display the calculated power supply available time, or when the user touches the usage cost settlement displayed on the display 10, may calculate a discount rate or an additional rate as described above based on a real-time power consumption calculated through the processor 134 to settle and display the usage cost.

The IoT control device 130 may further include a sensor unit that detects the movement of the user, and determine that a risk situation has occurred based on the detected movement of the user and transmit risk situation notification information to the server 120.

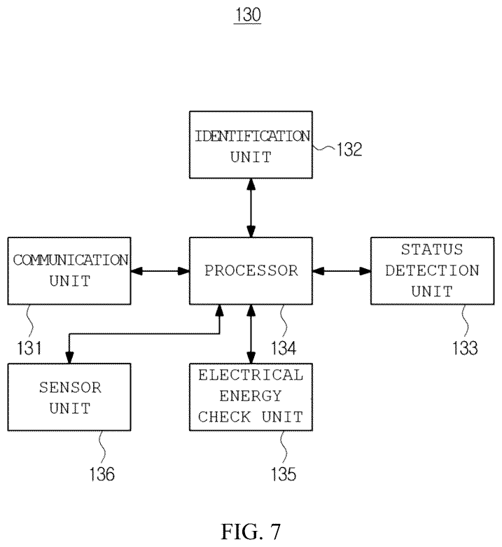

FIG. 7 is a diagram schematically illustrating a configuration of the IoT control device according to another embodiment of the present disclosure.

Referring to FIG. 7, the IoT control device 130 according to another embodiment of the present disclosure may include the communication unit 131, the identification unit 132, the status detection unit 133, the processor 134, the electrical energy check unit 135, and a sensor unit 136.

Here, the sensor unit 136 may detect the movement of the user, and may be implemented as a motion recognition camera, a laser sensor, an infrared sensor, a pressure sensor, a motion detection sensor, etc.

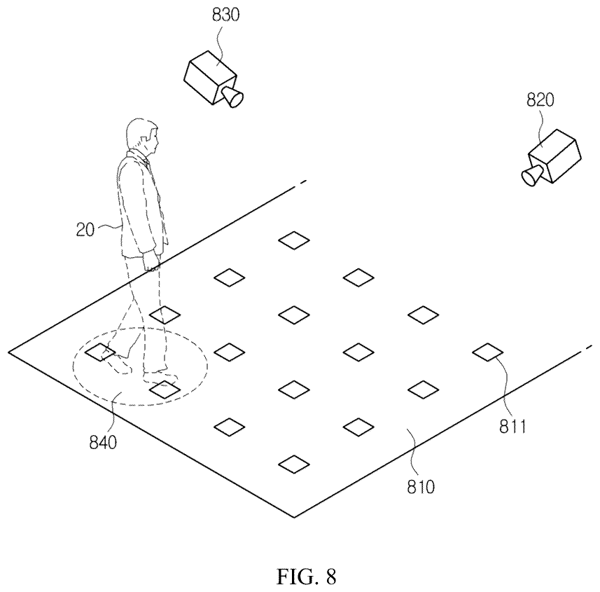

FIG. 8 is a diagram schematically illustrating a risk situation notification system of a tiny home according to an embodiment of the present disclosure.

FIG. 8 illustrates a case where the sensor unit 136 is implemented as cameras 820 and 830 and a pressure sensor 811 embedded in a floor 810. When a user 20 is detected by stepping on a pressure sensor 811 embedded in the floor while walking around the tiny home, the processor 134 of the IoT control device 130 may determine a point 840 where a user 20 is located, thereby detecting where the user 20 is moving and directly detecting a movement of the user 20 through the cameras 820 and 830.

In a case where the tiny home is away from an urban area and often lacks adequate medical facilities, the feature of detecting whether the user is moving within the tiny home and determining whether a risk situation exists may play a significant role.

Accordingly, the IoT control device 130 may determine whether a risk situation occurs by looking at a movement of the user detected through the sensor unit 136.

For example, when the IoT control device 130 determines that a movement of the user detected through the sensor unit 136 has stopped for a preset period of time or more, the pressure sensor is applied with an impact greater than or equal to a preset size, and the movement of the user is not detected at all, the IoT control device 130 may determine that a risk situation has occurred and transmits the risk situation notification information to the server 120 to notify the user or call an emergency system.

As described above, not only hardware devices such as a motion recognition camera, a laser sensor, an infrared sensor, a pressure sensor, and a motion detection sensor, but also abnormality detection algorithms or abnormal behavior pattern detection algorithms in a software form may be used to monitor a behavioral pattern of a user in the tiny home, and when an abnormal behavior pattern is detected, the risk situation notification information may be transmitted to the server 120 based on the detection.

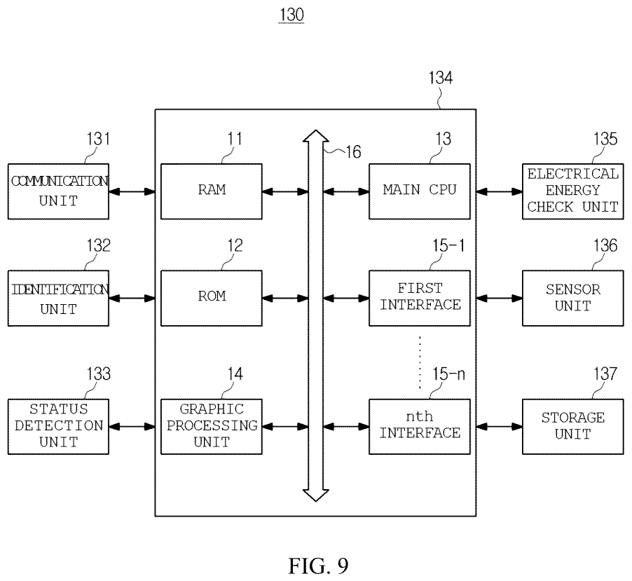

FIG. 9 is a block diagram schematically illustrating a detailed configuration of the IoT control device according to an embodiment of the present disclosure.

Referring to FIG. 9, the IoT control device 130 may include the communication unit 131, the identification unit 132, the status detection unit 133, the processor 134, the electrical energy check unit 135, the sensor unit 136, and/or a storage unit 137. Examples of the storage unit 137 may include, but are not limited to, Hard Disk Drives (HDD), Solid State Drives (SSD), Optical Discs (CD, DVD, Blu-Ray), USB Flash Drives, External Hard Drives, Memory Cards (SD Card, MicroSD Card), Network Attached Storage (NAS), Cloud Storage, Magnetic Tape Drives, RAM (Random Access Memory), Smart Cards, Internal Mobile Storage (eMMC, UFS), Hybrid Drives (SSHD), Digital Video Recorders (DVR) and Personal Video Recorders (PVR), Embedded Storage in IoT Devices, RAID Arrays, and a combination thereof.

The processor 134 may control the overall operation of the IoT control device 130.

For example, the processor 134 may include a RAM 11, a ROM 12, a main CPU 13, a graphic processing unit 14, first to n-th interfaces 15-1 to 15-n, and/or a bus 16. Here, “n” may be a natural number greater than one (1).

The RAM 11, the ROM 12, the main CPU 13, the graphic processing unit 14, the first to n-th interfaces 15-1 to 15-n, etc., may be connected to each other via the bus 16.

The first to n-th interfaces 15-1 to 15-n may be connected to various components described above. One of the interfaces may be a network interface connected to an external device through a network.

The main CPU 13 may access the storage unit 137 to perform booting using the O/S stored in the storage unit 137. The main CPU 13 may perform various operations using various programs, contents, data, and the like, stored in the storage unit 137.

For example, when the user is identified through the identification unit, the main CPU 13 may set the IoT-based controllable device equipped in the selected tiny home differently by the reservation date and time selected by the user.

An instruction set for booting a system, or the like, is stored in the ROM 12. When a turn-on command is input to supply power, the main CPU 13 may copy an operating system (O/S) stored in the storage unit 137 to the RAM 11 depending on an instruction stored in the ROM 12, and execute the O/S to boot the system. When the booting is completed, the main CPU 13 may copy various application programs stored in the storage unit 137 to the RAM 11, and execute the application programs copied to the RAM 11 to perform various operations.

The graphic processing unit 14 may generate a screen including various objects, such as an icon, an image, and a text, using a calculator (not illustrated) and a renderer (not illustrated). The calculator (not illustrated) calculates attribute values, such as coordinate values, forms, sizes, and colors at which the respective objects will be displayed depending on a layout of the screen on the basis of the received control command. The renderer (not illustrated) generates screens of various layouts including objects on the basis of the attribute values calculated in the calculator (not illustrated).

For example, the graphic processing unit 14 may implement objects generated by the main CPU 13 as a graphic user interface (GUI), an icon, a user interface screen, and the like. Examples of the graphic processing unit 14 may include, but are not limited to, Dedicated Graphics Cards, Integrated GPUs, Custom Embedded GPUs, Console GPUs, Mobile GPUs, External GPUs, and a combination thereof.

The operation of the processor 134 described above may be performed by a program stored in the storage unit 137.

The storage unit 137 stores various data such as an O/S software module for driving an IoT control device 130 for differently setting IoT-based controllable devices provided in the selected tiny home by the reservation date and time selected by the user when the user is identified through the identification unit, and various data such as various types of multimedia content.

For example, when the user is identified through the identification unit, the storage unit 137 may include a software module for differently setting the IoT-based controllable device provided in the selected tiny home by the reservation date and time selected by the user.

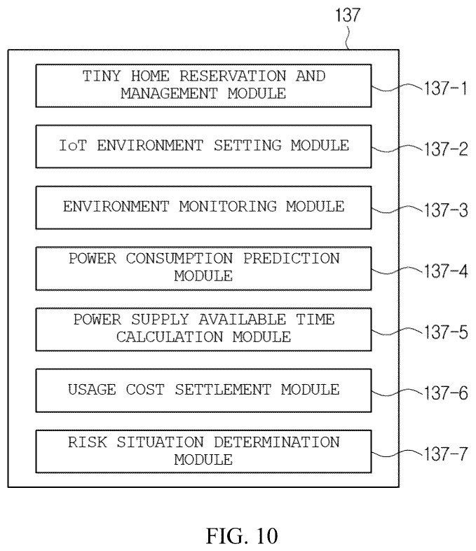

FIG. 10 is a diagram schematically illustrating a software module stored in a storage unit according to an embodiment of the present disclosure.

Referring to FIG. 10, the storage unit 137 may store programs such as a tiny home reservation and management module 137-1, an IoT environment setting module 137-2, an environment monitoring module 137-3, a power consumption prediction module 137-4, a power supply available time calculation module 137-5, a usage cost settlement module 137-6, and a risk situation determination module 137-7.

The operation of the processor 134 described above may be performed by a program stored in the storage unit 137. Hereinafter, the detailed operation of the processor 160 using the program stored in the storage unit 170 will be described in detail.

For example, the tiny home reservation and management module 137-1 may perform functions such as receiving and storing the reservation information on the online reservation site for the one or more tiny homes or monitoring and managing the status of the tiny home.

The IoT environment setting module 137-2 may set the IoT environment of the selected tiny home in response to the reservation date and time selected by the user based on the reservation information and environment setting information received from the server.

The environment monitoring module 137-3 may monitor and store the status of the IoT-based controllable device provided in the tiny home.

The power consumption prediction module 137-4 may predict the power consumption of the IoT-based controllable devices provided in the selected tiny home based on the reservation information and environment setting information on the selected tiny home.

The power supply available time calculation module 137-5 may calculate the power supply available time by comparing the increase/decrease rate of the power consumption calculated in real time with the charge amount of the battery.

The usage cost settlement module 137-6 may settle the usage cost of the selected tiny home based on the power consumption calculated in real time.

The risk situation determination module 137-7 may determine whether the risk situation occurs based on the detected movement of the user.

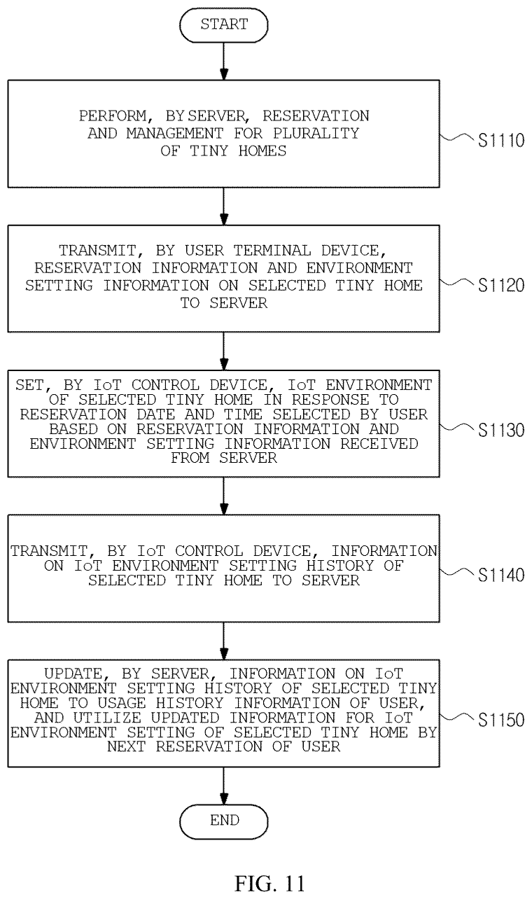

FIG. 11 is a flowchart schematically illustrated a control method of an IoT-based tiny home management system according to an embodiment of the present disclosure.

Referring to FIG. 11, the control method of an IoT-based tiny home management system including a server, a user terminal device, and an IoT control device may include performing, by a server, reservation and management for one or more tiny homes (S1110), transmitting, by the user terminal device, reservation information and environment setting information on a selected tiny home to the server (S1120), setting, by the IoT control device, an IoT environment of the selected tiny home in response to a reservation date and time selected by the user based on the reservation information and environment setting information received from the server (S1130), transmitting, by the IoT control device, information on an IoT environment setting history of the selected tiny home to the server (S1140), and updating, by the server, the information on the IoT environment setting history of the selected tiny home to usage history information of a user and utilizing the usage history information for IoT environment setting of a tiny home selected by a next reservation of the user (S1150).

All the operation processes of the processor 134 described above may be applied to the control method of an IoT-based tiny home management system including the server, the user terminal device, and the IoT device.

A non-transitory computer readable medium in which a program sequentially performing the controlling method according to the present disclosure is stored may be provided.

The non-transitory computer readable medium may mean a medium that semi-permanently or permanently stores data and is readable by an apparatus. For example, the various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

The communication between each component in the IoT-based tiny home management system or the IoT control device may be performed, e.g., via a bus. A processor, such as a central processing unit (CPU) and a microprocessor, performing various steps described above may be further included in each device.

According to various embodiments of the present disclosure as described above, the environment of the tiny home may be automatically controlled by reserved date and time according to the online reservation information and environment setting information and the user may live in the tiny home set to the environment he wants, thereby increasing the user convenience and satisfaction. With regard to the power and water usages which are very important in managing the tiny home, stable energy supply using the independent power and system and battery energy storage systems (BESS) can be implemented through the technology of monitoring and controlling various products provided in the tiny home.

The foregoing description provides illustrative examples of the technical features of the present disclosure. It should be understood by those skilled in the relevant art that various modifications and alterations may be made without departing from the scope and spirit of the disclosure. Accordingly, the embodiments described herein may be implemented independently or in various combinations.

The embodiments presented are not intended to limit the technical scope or spirit of the disclosure, but rather to provide a clear understanding of its concepts. The scope of protection should be defined by the following claims and interpreted to include all technical variations and equivalents that fall within the broader spirit and scope of the disclosure.

In the present disclosure, the primary focus is on “tiny homes” as a representative example. However, it should be understood that the disclosed technology is not limited solely to tiny homes but is intended to encompass all types of built environments, including but not limited to rental houses, student housing, senior assisted living facilities, permanent residences, and other similar spaces. The disclosure is designed to provide versatile solutions for monitoring, controlling, and managing various aspects of these built environments for the efficient management of building utilities, security, and maintenance. Therefore, the scope and spirit of the disclosure extend to all such environments, offering adaptability and functionality to meet the diverse needs of different living spaces.

What is claimed is:

1. An IoT-based home management system, comprising:
a server that performs reservation and management for one or more homes;
a user terminal device that transmits reservation information and environment setting information on a selected home to the server; and
an IoT control device that is provided in each of the one or more homes and sets an IoT environment of the selected home in response to a reservation date and time selected by a user based on the reservation information and environment setting information received from the server, wherein
the IoT control device transmits information on an IoT environment setting history of the selected home to the server, and
the server updates the information on the IoT environment setting history of the selected home to usage history information of the user, and utilizes the usage history information for IoT environment setting of a home selected by a next reservation of the user.

2. The IoT-based home management system of claim 1, wherein the environment setting information includes information for setting an IoT-based controllable device provided in the selected home, and includes information for setting the IoT-based controllable device differently by each reservation date and time.

3. The IoT-based home management system of claim 2, wherein the IoT control device includes:
a communication unit that receives reservation information and environment setting information on the selected home from the server;
an identification unit that identifies the user;
a status detection unit that monitors a status of an IoT-based controllable device provided in the selected home; and
a processor that sets the IoT-based controllable device provided in the selected home differently by the reservation date and time selected by the user when the user is identified through the identification unit.

4. The IoT-based home management system of claim 3, wherein
the server predicts power consumption of the IoT-based controllable device provided in the selected home based on the reservation information and environment setting information on the selected home and transmits predicted power consumption information to the IoT control device, and
the IoT control device calculates the power consumption of the IoT-based controllable device provided in the selected home in real time, and compares the power consumption calculated in real time with the predicted power consumption information.

5. The IoT-based home management system of claim 4, wherein
the IoT control device further includes an electrical energy check unit that checks a charge amount of a recycled battery provided in the selected home; and
the processor calculates an increase/decrease rate of the power consumption calculated in real time, and compares the calculated increase/decrease rate with the charge amount of the recycled battery to calculate a power supply available time.

6. The IoT-based home management system of claim 5, wherein the processor determines whether to replace the recycled battery based on the calculated power supply available time, transmits battery replacement request information to the server, and settles a usage cost of the selected home based on the power consumption calculated in real time.

7. The IoT-based home management system of claim 6, wherein
the IoT control device further includes a sensor unit that detects movement of the user, and
when the sensor unit determines that a risk situation occurs based on the detected movement of the user, the IoT control device transmits risk situation notification information to the server.

8. A control method of an IoT-based home management system including a server, a user terminal device, and an IoT control device, the control method comprising:
performing, by a server, reservation and management for one or more homes;
transmitting, by the user terminal device, reservation information and environment setting information on a selected home to the server;
setting, by the IoT control device, an IoT environment of the selected home in response to a reservation date and time selected by a user based on the reservation information and environment setting information received from the server;
transmitting, by the IoT control device, information on an IoT environment setting history of the selected home to the server; and
updating, by the server, the information on the IoT environment setting history of the selected home to usage history information of the user and utilizing the usage history information for IoT environment setting of a home selected by a next reservation of the user.

9. The control method of claim 8, wherein the environment setting information includes information for setting an IoT-based controllable device provided in the selected home, and includes information for setting the IoT-based controllable device differently by each reservation date and time.

10. The control method of claim 9, wherein the IoT control device includes:
a communication unit that receives reservation information and environment setting information on the selected home from the server;
an identification unit that identifies the user;
a status detection unit that monitors a status of an IoT-based controllable device provided in the selected home; and
a processor that sets the IoT-based controllable device provided in the selected home differently by the reservation date and time selected by the user when the user is identified through the identification unit.

11. The control method of claim 10, further comprising:
predicting, by the server, power consumption of the IoT-based controllable device provided in the selected home based on the reservation information and environment setting information on the selected home and transmitting predicted power consumption information to the IoT control device, and
calculating, by the IoT control device, the power consumption of the IoT-based controllable device provided in the selected home in real time, and comparing the power consumption calculated in real time with the predicted power consumption information.

12. The control method of claim 11, further comprising:
checking, by an electrical energy check unit of the IoT control device, a charge amount of a recycled battery provided in the selected home; and
calculating, by the processor, an increase/decrease rate of the power consumption calculated in real time, and comparing the calculated increase/decrease rate with the charge amount of the recycled battery to calculate a power supply available time.

13. The control method of claim 12, further comprising:
determining, by the processor, whether to replace the recycled battery based on the calculated power supply available time, transmitting battery replacement request information to the server, and settling a usage cost of the selected home based on the power consumption calculated in real time.

14. The control method of claim 13, wherein
the IoT control device further includes a sensor unit that detects movement of the user, and
the control method further comprises transmitting, by the IoT control device, risk situation notification information to the server when the sensor unit determines that a risk situation occurs based on the detected movement of the user.
